(19) United States
(12) Patent Application Publication
(10) Pub. No.: US 2026/0028255 A1
(43) Pub. Date: Jan. 29, 2026

(54) APPARATUS FOR TREATING WASTEWATER AND METHOD OF TREATING WASTEWATER

(71) Applicant: SAMSUNG ELECTRONICS CO., LTD., Suwon-si (KR)

(72) Inventors: Seungbae OH, Suwon-si (KR); Minji KIM, Suwon-si (KR); Jehun KIM, Suwon-si (KR); Soojin SHIM, Suwon-si (KR); Wooram LEE, Suwon-si (KR)

(73) Assignee: SAMSUNG ELECTRONICS CO., LTD., Suwon-si (KR)

(21) Appl. No.: 19/028,165

(22) Filed: Jan. 17, 2025

(30) Foreign Application Priority Data
Jul. 29, 2024 (KR) 10-2024-0100551

(51) Int. Cl. C02F 1/52; C02F 101/10

(52) U.S. Cl. CPC C02F 1/52; C02F 2001/5218; C02F 2101/101; C02F 2201/002; C02F 2209/19; C02F 2301/024

(57) ABSTRACT

A method of treating wastewater includes supplying, to a stirring tank, wastewater which includes sulfate ions and is stored in a collecting tank, supplying a solvent to the stirring tank into which the wastewater is supplied, forming sulfuric acid crystals by stirring the wastewater and the solvent supplied to the stirring tank, and supplying, to a separation tank, a mixture solution of the sulfuric acid crystals and treated water which is the wastewater from which the sulfuric acid crystals have been precipitated, and separating the sulfuric acid crystals and the treated water from each other in the separation tank, wherein the solvent is hydrophilic but has low affinity for the sulfate ions.

### CROSS-REFERENCE TO RELATED APPLICATIONS

This application is based on and claims priority to Korean Patent Application No. 10-2024-0100551, filed on Jul. 29, 2024, in the Korean Intellectual Property Office, the disclosure of which is incorporated by reference herein in its entirety.

### BACKGROUND

The present disclosure relates to an apparatus for treating wastewater and a method of treating wastewater. The present disclosure particularly relates to an apparatus for treating wastewater, the apparatus including a solvent supply device configured to supply, to a stirring tank, a solvent that is hydrophilic but has low affinity for sulfate ions, and a separation tank, and a method of treating wastewater by using the apparatus.

Semiconductor devices may be manufactured by performing numerous processes, such as a deposition process, a photolithography process, and a cleaning process. In the manufacturing processes described above, a large amount of wastewater including sulfate ions, sodium ions, chlorine ions, etc. is generated. The wastewater has environment pollution problems such as water pollution, and is thus discharged after undergoing a wastewater treating process. Among these, wastewater including sulfate ions is treated in various ways, such as by using heat energy or adding calcium-based chemicals. However, when heat energy is used in treating wastewater, a huge amount of heat energy is consumed, and when calcium-based chemicals are added for wastewater treatment, it is difficult to lower the concentration of the sulfate ions in the wastewater. Accordingly, research and development of a wastewater treating method for sufficiently lowering the concentration of sulfate ions in wastewater while reducing energy consumption is required.

### SUMMARY

The present disclosure provides an apparatus for treating wastewater and a method of treating wastewater, whereby energy is saved while sufficiently lowering the concentration of sulfate ions in the wastewater.

According to an aspect of the present disclosure, there is provided a method of treating wastewater, the method including supplying, to a stirring tank, wastewater which includes sulfate ions and is stored in a collecting tank, supplying a solvent to the stirring tank into which the wastewater is supplied, forming sulfuric acid crystals by stirring the wastewater and the solvent supplied to the stirring tank, and supplying, to a separation tank, a mixture solution of the sulfuric acid crystals and treated water which is the wastewater from which the sulfuric acid crystals have been precipitated, and separating the sulfuric acid crystals and the treated water from each other in the separation tank, wherein the solvent is hydrophilic but has low affinity for the sulfate ions.

According to another aspect of the present disclosure, there is provided an apparatus for treating wastewater, the apparatus including (A) a collecting tank configured to store wastewater including sulfate ions, (B) a stirring tank configured to form sulfuric acid crystals by stirring (i) the wastewater including the sulfate ions and (ii) a solvent, (C) a solvent supply device configured to supply a solvent to the stirring tank, and (D) a separation tank configured to separate the sulfuric acid crystals and treated water from each other, from a mixture solution of the sulfuric acid crystals and the treated water, wherein the treated water is the wastewater from which the sulfuric acid crystals have been precipitated, and wherein the solvent is hydrophilic but has low affinity for the sulfate ions.

According to another aspect of the present disclosure, there is provided a method of treating wastewater, the method including supplying, to a stirring tank, wastewater which includes sulfate ions and sodium ions and is stored in a collecting tank, supplying a solvent to the stirring tank into which the wastewater is supplied, forming sodium sulfate crystals by stirring the wastewater and the solvent supplied to the stirring tank, and supplying, to a separation tank, a mixture solution of the sodium sulfate crystals and treated water which is the wastewater from which the sodium sulfate crystals have been precipitated, and separating the sodium sulfate crystals and the treated water from each other in the separation tank, wherein the solvent is hydrophilic, but has low affinity for the sulfate ions, and the separation tank includes a precision filter.

### BRIEF DESCRIPTION OF DRAWINGS

Embodiments will be more clearly understood from the following detailed description taken in conjunction with the accompanying drawings in which:

FIG. 1 is a schematic diagram illustrating an apparatus for treating wastewater, according to embodiments;

FIG. 2 is a flowchart of a method of treating wastewater, according to embodiments; and

FIG. 3 is a graph showing results of X-ray diffraction analysis of sulfuric acid crystals crystallized by a method of treating wastewater, according to embodiments.

### DETAILED DESCRIPTION

Hereinafter, embodiments will be described in detail with reference to the attached drawings. In the drawings, like elements are labeled with like reference numerals and repeated description thereof will be omitted.

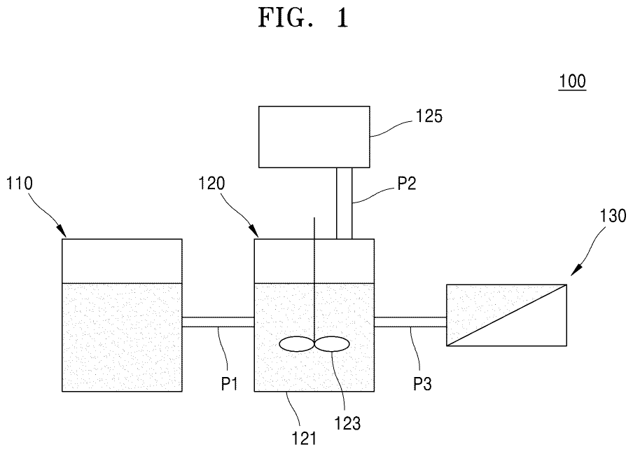

FIG. 1 is a schematic diagram showing an apparatus 100 for treating wastewater, according to embodiments.

Referring to FIG. 1, the apparatus 100 for treating wastewater may include a collecting tank 110, a stirring tank 120, and a separation tank 130.

The collecting tank 110 may store, for a certain period of time, wastewater discharged after a semiconductor manufacturing process is performed.

In the stirring tank 120, sulfate ions included in the wastewater may be crystallized from the wastewater supplied from the collecting tank 110 through a first pump P1. The stirring tank 120 may include a reaction tank 121 and a stirring device 123. The reaction tank 121 may store the wastewater supplied from the collecting tank 110 through the first pump P1, during a crystallization process of the sulfate ions included in the wastewater.

The stirring device 123 may include stirring blades and a stirring motor. The stirring motor may provide power to the stirring blades to rotate the stirring blades. The stirring blades may be configured to rotate during the crystallization process of sulfate ions included in the wastewater to crystallize the sulfate ions.

A solvent supply device 125 may be configured to supply a solvent for crystallizing sulfate ions to the stirring tank 120. The solvent may be supplied from the solvent supply device 125 to the stirring tank 120 via a second pump P2.

The separation tank 130 may be configured to separate and discharge the sulfuric acid crystals and treated water from a mixture solution of the sulfuric acid crystals formed through the crystallization process in the stirring tank 120 and the treated water from which the sulfuric acid crystals are precipitated. Here, the treated water may refer to wastewater from which sulfuric acid crystals have been precipitated through the crystallization process.

The mixture solution of the sulfuric acid crystals and the treated water that have undergone a stirring process may be supplied to the separation tank 130 through a third pump P3.

In embodiments, the separation tank 130 may include a precision filter having pores. In embodiments, the precision filter may include a membrane including a polymer that is chemically resistant to sulfate ions. For example, the precision filter may include a membrane including polyvinylidene fluoride (PVDF) or polytetrafluoroethylene (PTFE).

In embodiments, the pore size of the precision filter may be from about 0.2 μm to about 1.0 μm. In embodiments, the porosity of the precision filter may be from about 30% to about 85%. In embodiments, a driving pressure of the precision filter may be from about 0.5 bar to about 5.0 bar. For purposes of this specification, the term “about” means±5%.

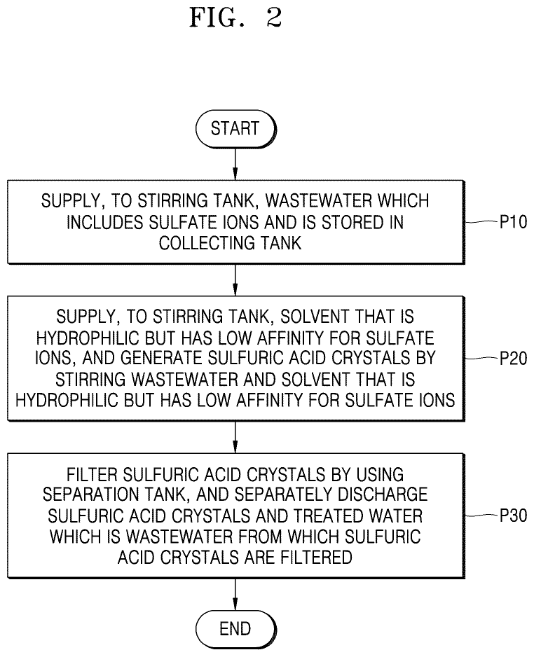

FIG. 2 is a flowchart of a method of treating wastewater, according to embodiments.

Referring to FIGS. 1 and 2 together, first, wastewater which includes sulfate ions and is stored in the collecting tank 110 may be supplied to the reaction tank 121 of the stirring tank 120 in operation P10. In embodiments, the wastewater which includes sulfate ions and is stored in the collecting tank 110 may be supplied to the reaction tank 121 via the first pump P1. In embodiments, a supply flow rate of the wastewater supplied from the collecting tank 110 to the reaction tank 121 may be about 10 m³/hr.

In embodiments, the wastewater may include sulfate ions. In embodiments, the wastewater may further include sodium ions, chloride ions, ammonium ions, magnesium ions, calcium ions or a combination thereof. In this case, the concentration of sulfate ions included in the wastewater may be relatively higher than the respective concentrations of sodium ions, chlorine ions, ammonium ions, magnesium ions, and calcium ions included in the wastewater.

In embodiments, the concentration of the sulfate ions included in the wastewater may be from about 150 mg/L to about 15000 mg/L. For example, the concentration of the sulfate ions included in the wastewater may be about 1970 mg/L.

In embodiments, a pH value of the wastewater may range from about 3 to about 11. If the pH value of the wastewater is outside the above-described range, the crystallization of sulfate ions, which will be described later, may be inhibited. For example, when the pH value of the wastewater is lower than about 3, the solvent supplied to the reaction tank 121 may be decomposed during a crystallization process of sulfate ions, which is described later, and the crystallization of sulfate ions may be hindered.

In embodiments, a temperature of the wastewater may be from about 10° C. to about 40° C. If the temperature of the wastewater exceeds the above-described range, the crystallization of sulfate ions, which will be described later, may be hindered. For example, if the temperature of the wastewater exceeds 40° C., the solvent supplied to the reaction tank 121 may evaporate during the crystallization process of sulfate ions described later, and the crystallization of sulfate ions may be hindered.

Next, a solvent may be supplied from the solvent supply device 125 to the reaction tank 121 of the stirring tank 120 storing wastewater supplied from the collecting tank 110 in operation P20. In embodiments, the solvent may be supplied to the reaction tank 121 via the second pump P2.

In embodiments, the solvent may be an organic solvent that is hydrophilic but has low affinity for sulfate ions. For example, the solvent may include ethanol, acetone, n-propylamine, isopropylamine, or a combination thereof.

In embodiments, a ratio of a supply flow rate of the wastewater supplied from the collecting tank 110 to the reaction tank 121 to a supply flow rate of the solvent supplied to the reaction tank 121 may be about 1:1 to about 1:4. For example, when the supply flow rate of wastewater supplied from the collecting tank 110 to the reaction tank 121 is about 10 m³/hr, the supply flow rate of the solvent supplied to the reaction tank 121 may be about 40 m³/hr. When the ratio of the supply flow rate of the solvent to the supply flow rate of the wastewater satisfies the above-described range, the crystallization of sulfate ions, which will be described later, may be promoted.

Next, the solvent and the wastewater supplied to the reaction tank 121 may be stirred using the stirring device 123 of the stirring tank 120 to form sulfuric acid crystals in operation P20. Since the solvent is an organic solvent that is hydrophilic but has low affinity for sulfate ions, when the solvent is supplied to the reaction tank 121 and then a stirring process is performed, the sulfate ions, which are anions dissolved in the wastewater stored in the reaction tank 121, may crystallize with cations dissolved in the wastewater and be precipitated from the wastewater. For example, if the wastewater stored in the reaction tank 121 includes sulfate ions and sodium ions, the sulfate ions may form crystals with the sodium ions through the stirring process, and accordingly, sodium sulfate may be precipitated from the wastewater.

In embodiments, a rotation speed per minute of the stirring device 123 during the stirring process may be about 50 rpm to about 150 rpm. If the rotation speed per minute of the stirring device 123 is outside the above-described range, crystallization of sulfate ions, which will be described later, may be hindered. For example, if the rotation speed per minute of the stirring device 123 is less than about 50 rpm, the crystallization reaction of sulfate ions may be excessively slow.

In embodiments, the stirring process for forming the sulfuric acid crystals may be performed for about 5 minutes to about 60 minutes. For example, the stirring process may be performed for about 10 minutes to about 30 minutes.

Next, the mixture solution of sulfuric acid crystals formed by the stirring process described above and the treated water after the sulfuric acid crystals are formed may be separated using the separation tank 130, and the sulfuric acid crystals and the treated water may be separately discharged from the separation tank 130 in operation P30.

In embodiments, the pore size of the precision filter may be from about 0.2 μm to about 1.0 μm. If the pore size of the precision filter is outside the above-described range, the treated water and sulfuric acid crystals may not be properly separated from each other.

According to the method of treating wastewater, according to the embodiments, sulfate ions dissolved in wastewater may be crystallized using a hydrophilic solvent having low affinity for sulfate ions, and the sulfate ions may be separated from the treated water and discharged by using the separation tank 130.

According to the method of treating wastewater, according to embodiments, energy required for a wastewater treating process may be saved because sulfate ions may be crystallized without using heat energy.

In addition, when precipitating ions in the wastewater by evaporating the moisture in the wastewater by using heat energy, mixed crystals of various ions included in the wastewater are precipitated. However, according to the method of treating wastewater in embodiments of the present disclosure, crystallization between the anions, that is, sulfate ions, and the cations included in the wastewater is induced using a solvent, and thus high-purity sulfuric acid crystals may be precipitated. Accordingly, unlike mixed crystals, the sulfuric acid crystals may be recycled, thereby improving the economic feasibility of the semiconductor manufacturing process.

In addition, when crystallizing sulfate ions by adding a calcium-based chemical, the concentration of sulfate ions in wastewater cannot be sufficiently reduced due to the high water solubility of calcium sulfate crystals crystallized by the calcium-based chemical. However, the sodium sulfate crystals crystallized by the method of treating wastewater according to embodiments have relatively low water solubility and thus the concentration of sulfate ions in the wastewater may be sufficiently lowered.

Hereinafter, the effect of the method of treating wastewater according to embodiments is described in detail based on embodiments.

TABLE 1

| Element | Concentration (mg/L) |
|---|---|
| SO₄²⁻ (sulfate ions) | 1970 |
| Na⁺ (sodium ions) | 982 |
| Cl⁻ (chlorine ions) | 852 |
| Mg²⁺ (magnesium ions) | 167 |
| Ca²⁺ (calcium ions) | 154 |

Table 1 shows a composition of wastewater that is subject to the method of treating wastewater. A pH value of the wastewater having the composition of Table 1 is about 5.9, and the electrical conductivity of the wastewater is about 7761 μS/cm.

After the wastewater having the composition of Table 1 and stored in the collecting tank 110 (see FIG. 1) was supplied to the reaction tank 121 (see FIG. 1) of the stirring tank 120 (see FIG. 1), ethanol, acetone, n-propylamine, and isopropylamine were supplied, at different flow rates, to the reaction tank 121 (see FIG. 1) storing the wastewater having the composition of Table 1.

Next, a stirring process was performed for 30 minutes at a rotation speed of 60 rpm of the stirring device 123 (see FIG. 1). After the stirring process, sulfuric acid crystals and treated water were moved to the separation tank 130 (see FIG. 1), and the sulfuric acid crystals and the treated water were separated from each other using the separation tank 130 (see FIG. 1), and the concentration of the sulfuric acid crystals in the treated water was measured. In the separation tank 130, a precision filter including PVDF was used, and the pore size of the precision filter was approximately 0.45 μm.

TABLE 2

| | | Injection Amount of Solvent into | | | |
|---|---|---|---|---|---|
| | | Stirring Tank (Volume of Injected | | | |
| | | Solvent with Respect to Wastewater) | | | |
| | | 1.0 times | 2.0 times | 3.0 times | 4.0 times |
| ethanol | concentration of final | 582 | 350 | 204 | 67 |
| | processed sulfate ions | | | | |
| | (mg/L) | | | | |
| acetone | concentration of final | 590 | 351 | 128 | 43 |
| | processed sulfate ions | | | | |
| | (mg/L) | | | | |
| n-propylamine | concentration of final | 910 | 527 | 153 | 79 |
| | processed sulfate ions | | | | |
| | (mg/L) | | | | |
| isopropylamine | concentration of final | 909 | 459 | 149 | 87 |
| | processed sulfate ions | | | | |
| | (mg/L) | | | | |

Referring to Table 2, in all cases where ethanol, acetone, n-propylamine, and isopropylamine were used as a solvent, respectively, it is confirmed that the concentration of sulfate ions after the stirring process was the lowest when the ratio of the supply flow rate of wastewater to the supply flow rate of solvent was about 1:4. That is, it may be confirmed that crystallization of sulfate ions was best when the ratio of the supply flow rate of wastewater to the supply flow rate of solvent was about 1:4.

In addition, considering that the concentration of sulfate ions in the wastewater before treatment is 1,970 mg/L, it may be confirmed that a sulfate ion treatment efficiency of 95% or higher is achieved in all cases where ethanol, acetone, n-propylamine, and isopropylamine were used as a solvent, respectively, when the ratio of the supply flow rate of the wastewater to the supply flow rate of the solvent is about 1:4.

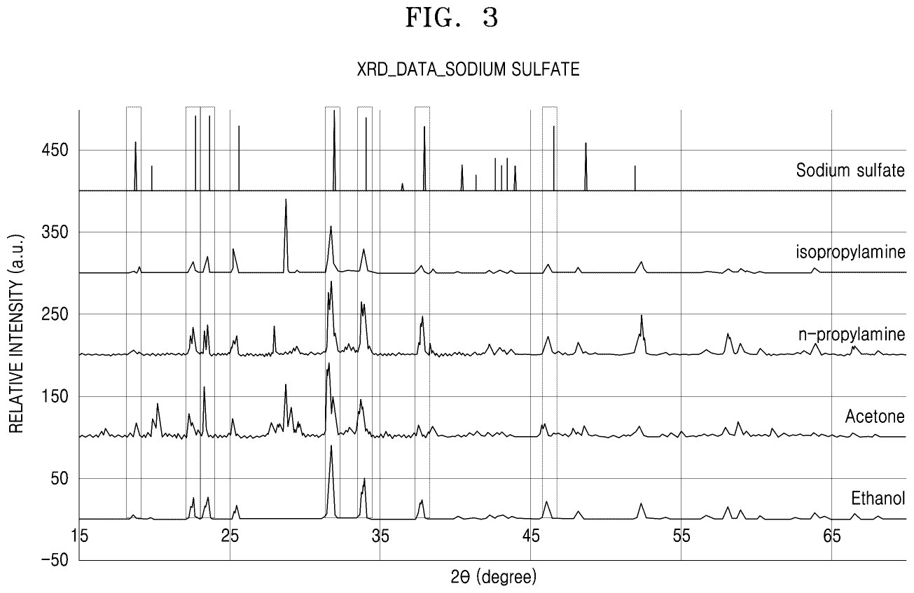

FIG. 3 is a graph showing results of X-ray diffraction analysis of sulfuric acid crystals crystallized by the method of treating wastewater, according to embodiments. FIG. 3 illustrates results of X-ray diffraction analysis of sulfuric acid crystals obtained by treating wastewater having the composition of Table 1 according to the method of treating wastewater according to embodiments.

TABLE 3

| Element Type | Composition Weight Ratio (wt %) |
|---|---|
| O | 33.67 |
| S | 32.76 |
| Na | 19.39 |
| C | 8.85 |
| Ca | 2.97 |
| F | 1.48 |
| Mg | 0.45 |
| K | 0.43 |
| Sum | 100 |

Table 3 is a table showing the results of analysis by energy dispersive X-ray spectroscopy of sulfuric acid crystals obtained by treating wastewater having the composition of Table 1 by using ethanol as a solvent by using the method of treating wastewater according to embodiments.

Referring to FIG. 3, the sulfuric acid crystals crystallized by the method of treating wastewater according to embodiments have an X-ray diffraction pattern of sodium sulfate when ethanol, acetone, n-propylamine, and isopropylamine were used as a solvent, respectively, that is, in all cases. That is, referring to FIG. 3, it may be confirmed that the sulfuric acid crystals crystallized by the method of treating wastewater according to embodiments were sodium sulfate.

Referring to Table 3, it may be confirmed that the sulfuric acid crystals obtained by treating wastewater having the composition of Table 1 by using ethanol as a solvent and according to the method of treating wastewater according to embodiments included oxygen (O), sulfur(S), and sodium (Na) as main components. That is, referring to Table 3, it may be confirmed that the sulfuric acid crystals obtained by treating wastewater according to embodiments were sodium sulfate.

That is, referring to FIG. 3 and Table 3, it may be confirmed that the sulfuric acid crystals crystallized by the method of treating wastewater according to embodiments were sodium sulfate. That is, unlike the mixed crystals of various ions obtained by crystallization using heat energy, it may be confirmed that high-purity sodium sulfate may be obtained through the method of treating wastewater according to embodiments.

While the present disclosure has been particularly shown and described with reference to embodiments thereof, it will be understood that various changes in form and details may be made therein without departing from the spirit and scope of the following claims.

What is claimed is:

1. A method of treating wastewater, the method comprising:
supplying, to a stirring tank, wastewater which includes sulfate ions and is stored in a collecting tank;
supplying a solvent to the stirring tank into which the wastewater is supplied;
forming sulfuric acid crystals by stirring the wastewater and the solvent supplied to the stirring tank; and
supplying, to a separation tank, a mixture solution of the sulfuric acid crystals and treated water which is the wastewater from which the sulfuric acid crystals have been precipitated, and separating the sulfuric acid crystals and the treated water from each other in the separation tank,
wherein the solvent is hydrophilic but has low affinity for the sulfate ions.

2. The method of claim 1, wherein a pH value of the wastewater is 3 to 11.

3. The method of claim 1, wherein a temperature of the wastewater is 10° C. to 40° C.

4. The method of claim 1, wherein a ratio of a supply flow rate of the wastewater to a supply flow rate of the solvent is 1:1 to 1:4.

5. The method of claim 1, wherein a ratio of a supply flow rate of the wastewater to a supply flow rate of the solvent is 1:4.

6. The method of claim 1, wherein a concentration of sulfate ions included in the wastewater is 150 mg/L to 15,000 mg/L.

7. The method of claim 1, wherein a stirring process is performed for 5 minutes to 60 minutes.

8. The method of claim 1, wherein the stirring tank includes a stirring device, and a rotational speed of the stirring device is 50 rpm to 150 rpm.

9. The method of claim 1, wherein the solvent comprises any one selected from n-propylamine, isopropylamine, acetone or ethanol.

10. The method of claim 1, wherein the separation tank comprises a precision filter.

11. An apparatus for treating wastewater, the apparatus comprising:
a collecting tank configured to store wastewater including sulfate ions;
a stirring tank configured to form sulfuric acid crystals by stirring (i) the wastewater including the sulfate ions and (ii) a solvent;
a solvent supply device configured to supply a solvent to the stirring tank; and
a separation tank configured to separate the sulfuric acid crystals and treated water from each other, from a mixture solution of the sulfuric acid crystals and the treated water,
wherein the treated water is the wastewater from which the sulfuric acid crystals have been precipitated, and
wherein the solvent is hydrophilic but has low affinity for the sulfate ions.

12. The apparatus of claim 11, wherein the separation tank comprises a precision filter including a membrane comprising polyvinylidene fluoride (PVDF) or polytetrafluoroethylene (PTFE).

13. The apparatus of claim 11, wherein the separation tank comprises a precision filter having pores with a pore size of 0.2 μm to 1.0 μm.

14. The apparatus of claim 11, wherein the separation tank comprises a precision filter having a porosity of 30% to 85%.

15. The apparatus of claim 11, wherein a driving pressure of the separation tank is 0.5 bar to 5.0 bar.

16. The apparatus of claim 11, wherein the solvent supplied by the solvent supply device comprises any one selected from n-propylamine, isopropylamine, acetone or ethanol.

17. A method of treating wastewater, the method comprising:
supplying, to a stirring tank, wastewater which includes sulfate ions and sodium ions and is stored in a collecting tank;
supplying a solvent to the stirring tank into which the wastewater is supplied;
forming sodium sulfate crystals by stirring the wastewater and the solvent supplied to the stirring tank; and
supplying, to a separation tank, a mixture solution of the sodium sulfate crystals and treated water which is the wastewater from which the sodium sulfate crystals have been precipitated, and separating the sodium sulfate crystals and the treated water from each other in the separation tank,
wherein the solvent is hydrophilic but has low affinity for the sulfate ions, and
the separation tank comprises a precision filter.

18. The method of claim 17, wherein a pH value of the wastewater is 3 to 11 and a temperature of the wastewater is 10° C. to 40° C.

19. The method of claim 17, wherein a ratio of a supply flow rate of the wastewater to a supply flow rate of the solvent is 1:1 to 1:4.

20. The method of claim 17, wherein the stirring tank includes a stirring device, a rotation speed of the stirring device is 50 rpm to 150 rpm, and a stirring process is performed for 5 minutes to 60 minutes.
